(19) United States
(12) Patent Application Publication
(10) Pub. No.: US 2013/0339986 A1
(43) Pub. Date: Dec. 19, 2013

(54) Disk Loading and Unloading Apparatus for Optical Disk Drive

(71) Applicant: LITE-ON IT CORPORATION, Taipei City (TW)

(72) Inventors: Shih-Ming Hsu, Hsinchu (TW); Hai-Sheng Hu, Hsinchu (TW); Zan-Xun Cen, Hsinchu (TW)

(73) Assignee: Lite-On IT Corporation, Taipei City (TW)

(21) Appl. No.: 13/869,061

(22) Filed: Apr. 24, 2013

(30) Foreign Application Priority Data
Jun. 13, 2012 (CN) 201210194686.3

(51) Int. Cl. G11B 17/028

(52) U.S. Cl. CPC G11B 17/0284
USPC 720/604

(57) ABSTRACT

A disk loading and unloading apparatus of an optical disk drive, the disk loading and unloading apparatus comprises: a chassis; a tray; a supporting frame pivoted on the chassis; a traverse; a spindle motor disposed on the traverse for supporting and rotating an optical disk; a sliding block slidably disposed on the chassis; and a cover. During the disk loading and unloading process, the sliding block drives the traverse and the spindle motor to move up and down to fix the optical disk on the spindle motor or to separate the optical disk from the spindle motor.

This application claims the benefit of People's Republic of China Application Serial No. 201210194686.3, filed Jun. 13, 2012, the subject matter of which is incorporated herein by reference.

### FIELD OF THE INVENTION

The present invention relates to a disk loading and unloading apparatus, and more particularly to a disk loading and unloading apparatus for a tray-type optical disk drive.

### BACKGROUND OF THE INVENTION

For a general tray-type optical disk drive, the tray mainly used to load and unload an optical disk into/out of the optical disk drive. When the optical disk is loaded into the optical disk drive by the tray, the optical disk needs to be clamped or fixed on the turntable. Once the turntable rotates the optical disk, the optical pick-up head can read the information from the optical disk.

In the conventional technology, the optical disk is clamped on the turntable of the optical disk drive via a magnetic mechanism. In this technology, a magnet is placed inside the turntable of the optical disk drive corresponding to an additional clamper disposed in the optical disk drive. When the optical disk is loaded into the optical disk drive, the optical disk is clamped between the turntable and the clamper by the magnetic force.

In another conventional technology, the optical disk is clamped on the turntable of the optical disk drive via an elastic mechanism. In this technology, an additional spring or an elastic leaf is additionally disposed in the optical disk drive corresponding to the turntable. When the optical disk is loaded into the optical disk drive, the optical disk is pressed on the turntable by the elastic force of the spring or the elastic leaf.

However, in the above-described technologies, the optical disk drive needs additional clamping elements such as a damper or a spring to clamp the optical disk. By doing so, the manufacturing cost is increased. In another conventional technology, a clamping mechanism is configured on the turntable to directly clamp the optical disk without other additional clamping elements. The clamping mechanism comprises a plural of elastic claws on the turntable to radially clasp the center hole of the optical disk.

However, in such a way, it is inconvenient for a user to manually depress the optical disk into the clamping mechanism of the turntable and manually unload the optical disk from the turntable.

### SUMMARY OF THE INVENTION

To solve the above-described problems, the present invention provides a disk loading and unloading apparatus for a tray-type optical disk drive to reduce the number of internal elements and the manufacturing cost of the optical disk drive. The present invention also provided the automatic disk loading and unloading operations for increasing the operation convenience.

The present invention provides a disk loading and unloading apparatus of an optical disk drive. The disk loading and unloading apparatus comprises: a chassis; a tray, moveably disposed on the chassis; a supporting frame, pivoted on the chassis and having a pin; a traverse, wherein one side of the traverse is disposed on the chassis and the other side of the traverse is deposed on the supporting frame; a spindle motor, disposed on the traverse and comprising a turntable for supporting an optical disk on a supporting plane and a clamping mechanism for clamping the center hole of the optical disk; and a sliding block, slidably disposed on the chassis and having a sliding groove, wherein the pin of the supporting frame slides along the sliding groove and the sliding groove comprises a first position with a first height, a second position with a second height and a third position with a third height, wherein the third height is between the first height and the second height; and a top cover, having a suppression portion, wherein, when the pin is located at the second position, the suppressing portion suppresses the optical disk to make the clamping mechanism to clamp the center hole of the optical disk.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is an exploded view of an optical disk drive in an embodiment of the present invention;

FIG. 2 is a perspective view of a sliding groove of a sliding block in an embodiment of the present invention;

FIG. 3 is a magnified view of a spindle motor in an embodiment of the present invention;

FIG. 4A-4C are diagrams showing the statuses when an optical disk is loaded into the optical disk drive in an embodiment of the present invention; and

FIG. 5 is a diagram showing an interference status between a tray and a optical disk in an embodiment of the present invention;

### DETAILED DESCRIPTION OF PREFERRED EMBODIMENTS

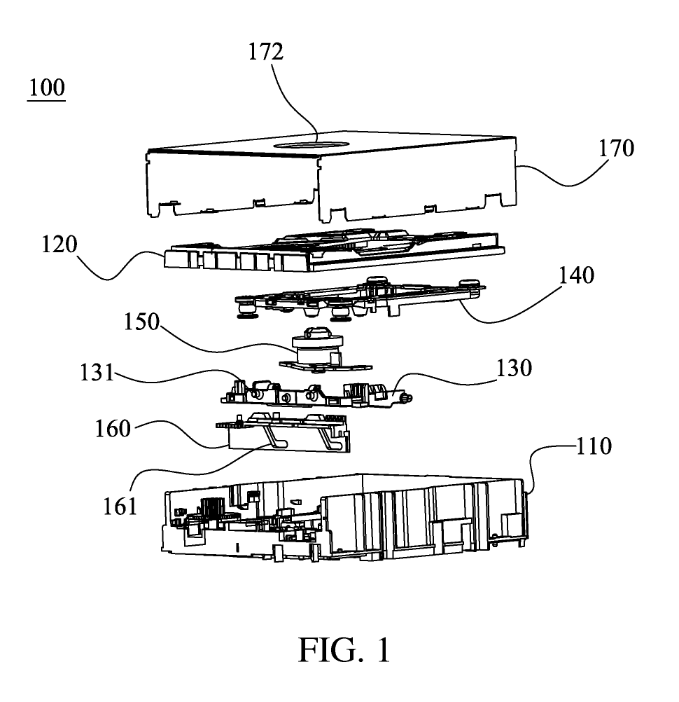

FIG. 1 is an exploded view of an optical disk drive 100 in an embodiment of the present invention. The optical disk drive 100 according to the embodiment of the present invention comprises: a chassis 110; a tray 120; a supporting frame 130; a traverse 140; a spindle motor 150; a sliding block 160; and a top cover 170. The tray 120 is moveably disposed on the chassis 110, and the supporting frame 130 is pivoted on the chassis 110. One side of the traverse 140 is disposed on the chassis 110 and the other side of the traverse 140 is disposed on the supporting frame 130. The spindle motor 150 is disposed on the traverse 140 for supporting and rotating the optical disk. The sliding block 160 is slidably disposed on the chassis 110.

According to an embodiment of the present invention, the sliding block 160 can move forward and backward on the chassis 110 and comprises at least a sliding groove 161. The supporting frame 130 comprises at least a pin 131 corresponding to the sliding groove 161 of the sliding block 160. When the sliding block 160 moves forward and backward on the chassis 110, the pin 131 moves relatively in the sliding groove 161.

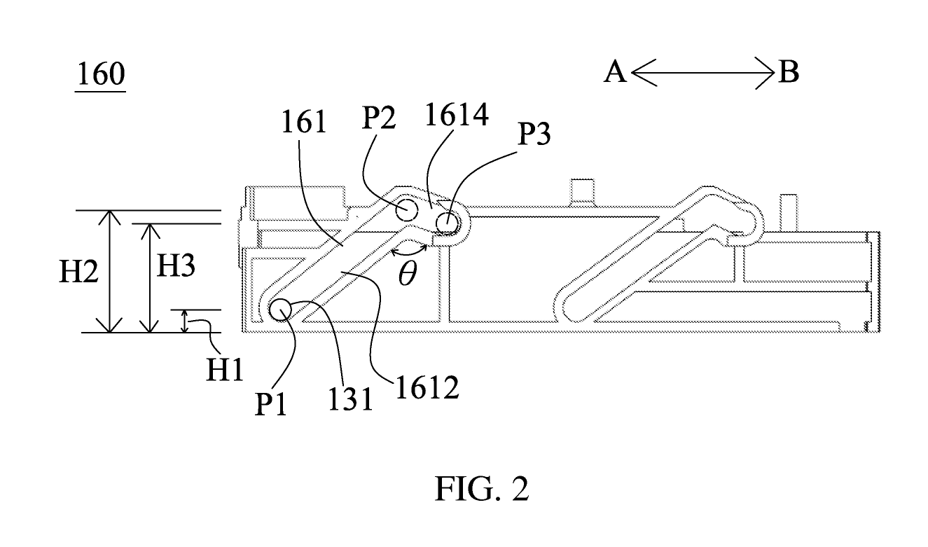

FIG. 2 is a perspective view of the sliding groove 161 of the sliding block 160 in an embodiment of the present invention. As shown in FIG. 2, the sliding groove 161 comprises a first inclined groove 1612 and a second inclined groove 1614. The length of the first inclined groove 1612 is longer than the length of the second inclined groove 1614, and an angle 0 is defined between the first inclined groove 1612 and the second inclined groove 1614.

According to an embodiment of the present invention, the pin 131 moves relatively in the sliding groove 161 of the sliding block 160. The sliding groove 161 of the sliding block 160 further comprises a first position P1 with a first height H1, a second position P2 with a second height H2 and a third position P3 with a third height H3, wherein the third height H3 is between the first height H1 and the second height H2.

According to an embodiment of the present invention, when the sliding block 160 moves toward a first direction A on the chassis 110, the pin 131 moves from the first position P1 along the first inclined groove 1612 to the second position P2 and then moves from the second position P2 along the second inclined groove 1614 to the third position P3. Besides, when the pin 131 moves relatively along the sliding groove 161 of the sliding block 160, the supporting frame 130 and traverse 140 are driven to swing up and down. Moreover, when the sliding block 160 moves toward a second direction B on the chassis 110, the pin 131 moves relatively along the sliding groove 161 in a reversing direction.

In other words, when the sliding block 160 moves toward the first direction A on the chassis 110, the pin 131 moves upwardly from the first height H1 to the second height H2 and then moves downwardly from the second height H2 to the third height H3. In contrast, when the sliding block 160 moves toward the second direction B on the chassis 110, the pin 131 moves reversely and upwardly from the third height H3 to the second height H2 and then moves downwardly from the second height H2 to the first height H1. According to an embodiment of the present invention, the forward and backward movement of the sliding block 160 can be driven by a motor gear assembly. The driving method of the sliding block 160 is not limited in the present invention.

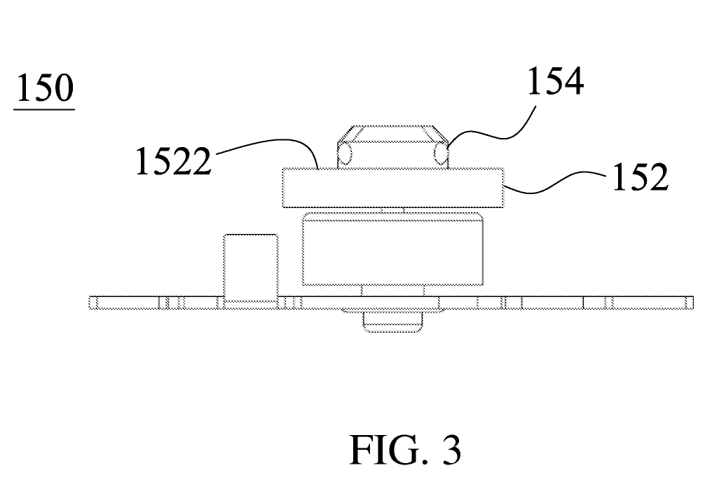

FIG. 3 is a magnified view of the spindle motor in an embodiment of the present invention. As shown in FIG. 3, the spindle motor 150 comprises a turntable 152 to support an optical disk on a supporting plane 1522. The turntable 152 comprises a clamping mechanism 154 to clamp and fix the center hole of the optical disk on the turntable 152.

Moreover, please refer to the FIG. 1, the top cover 170 of the optical disk drive 100 comprises a suppression portion 172 to suppress the optical disk into the clamping mechanism 154 on the spindle motor 150, therefore, to fix the optical disk on the turntable 152. The suppression portion 172 is inwardly protruded from top cover 170 to the inside of the optical disk drive 100. The suppression portion 172 can be a ring-type protrusion or an arc-type protrusion. The protrusion shape is not limited and can be modified by the person skilled in the art according to the practical application.

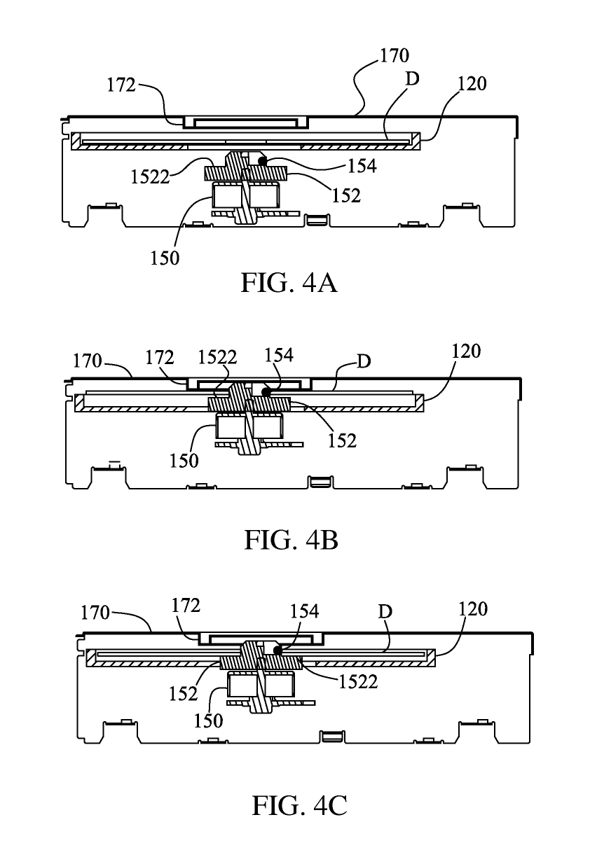

FIG. 4A-4C are diagrams showing the statuses when an optical disk is loaded into the optical disk drive 100 in an embodiment of the present invention. As shown in FIG. 4A, when the optical disk is not loaded into the optical disk drive 100, the pin 131 of the supporting frame 130 is positioned at the first height H1. Meanwhile, the supporting plane 1522 of the turntable 152 is lower than the tray 120, so that the tray 120 can be rejected from the optical disk drive 100 to load the optical disk according to a user's operation.

When the optical disk is loaded into the optical disk drive 100, the optical disk drive 100 drives the sliding block 160 to move toward the first direction A to raise the pin 131 of the supporting frame 130 from the first height H1 to the second height H2, as shown in FIG. 4B. When the pin 131 moves upwardly to the second height H2, the traverse 140 and the spindle motor 150 are also driven to move upwardly and then the supporting plane 1522 of the turntable 152 is higher than the tray 120. In the meantime, the optical disk D loaded on the tray 120 is lifted by the turntable 152 of the spindle motor 150 and is separated from the tray 120. Next, the suppression portion 172 of the top cover 170 to suppress the optical disk D to make the clamping mechanism 154 to clamp the center hole of the optical disk D and fix the optical disk D is fixed on the turntable 152.

Next, as shown in FIG. 4C, the optical disk drive 100 further drives the sliding block 160 to move toward the first direction A and the pin 131 of the supporting frame 130 moves downwardly from the second height H2 to the third height H3. When the pin 131 moves downwardly to the third height H3, the traverse 140 and the spindle motor 150 are also driven to move downwardly. In the meantime, the optical disk D fixed on the turntable 152 is also driven to move downwardly. The disk loading action is completed when the pin 131 is located at the third position P3 wherein the supporting plane 1522 of the turntable 152 is higher than the tray 120 and there is a predetermined distance between the optical disk D and the supporting plane of the tray 120. Afterward, the optical disk drive 100 can drive the spindle motor 150 to rotate the optical disk D and read the information from the optical disk D.

When the optical disk drive 100 intends to unload the optical disk D, the optical disk drive 100 drives the sliding block 160 to move in the reverse direction toward the second direction B. The pin 131 moves upwardly from the third height H3 to the second height H2 and then moves downwardly from the second height H2 to the first height H1 to unload the optical disk D. For the same movement described above, when the pin 131 moves correspondingly along the sliding groove 161, the supporting frame 130 and traverse 140 are driven to swing up and down.

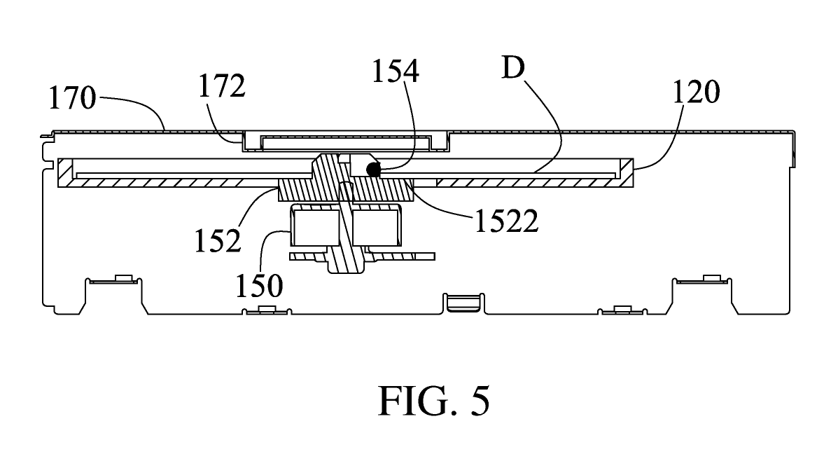

During the disk unloading process, when the pin 131 moves from the second height H2 to the first height H1, the supporting plane 1522 of the turntable 152 moves from a higher position above the tray 120 to a lower position below the tray 120. Therefore, the optical disk D fixed on the turntable 152 contacts with the tray 120 when the supporting plane 1522 of the turntable 152 moves to a lower position below the tray 120. The center hole of the optical disk D is separated from the clamping mechanism 154 of the turntable 152 and the optical disk D is reloaded on the tray 120 due to the interference with tray 120. As shown in FIG. 5, FIG. 5 is a diagram showing the interference status between the tray and the optical disk in one embodiment of the present invention. When the supporting plate 1522 of the turntable 152 is driven to move to a lower position below the tray 120, the optical disk D contacts with the tray 120 and is separated from the clamping mechanism 154 of the turntable 152 to be reloaded on the tray 120.

According to the disk loading and unloading apparatus of the optical disk drive provided by the present invention, no additional elements are necessary. The cost can be reduced to increase the marketing competitiveness. Moreover, during the disk loading and unloading process, the optical disk can be automatically fixed on the clamping mechanism of the turntable and separated from the clamping mechanism of the turntable to effectively increase the convenience of user operation.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A disk loading and unloading apparatus for an optical disk drive comprising:
a chassis;
a tray, moveably disposed on the chassis;
a supporting frame, pivoted on the chassis and having a pin;
a traverse, wherein one side of the traverse is disposed on the chassis and the other side of the traverse is deposed on the supporting frame;
a spindle motor, disposed on the traverse and comprising a turntable for supporting an optical disk on a supporting plane and a clamping mechanism for clamping the center hole of the optical disk; and
a sliding block, slidably disposed on the chassis and having a sliding groove, wherein the pin of the supporting frame slides along the sliding groove and the sliding groove comprises a first position with a first height, a second position with a second height and a third position with a third height, wherein the third height is between the first height and the second height; and
a top cover, having a suppression portion,
wherein, when the pin is located at the second position, the suppressing portion suppresses the optical disk to make the clamping mechanism to clamp the center hole of the optical disk.

2. The disk loading and unloading apparatus as claimed in claim 1, wherein the optical disk is separated from the tray with a predetermined distance when the pin is located at the third height.

3. The disk loading and unloading apparatus as claimed in claim 1, wherein when the pin is located at the first height, the supporting plane of the turntable is below the tray; when the pin is located at the second height and the third height, the supporting plane of the turntable is above the tray.

4. The disk loading and unloading apparatus as claimed in claim 1, wherein when the pin moves relatively along the sliding groove, the spindle motor and traverse are driven to swing up and down.

5. The disk loading and unloading apparatus as claimed in claim 1, wherein when the optical disk is loaded, the optical disk drive drives the sliding block to move toward a first direction and the pin moves upwardly from the first height to the second height and then move downwardly from the second height to the third height.

6. The disk loading and unloading apparatus as claimed in claim 1, wherein when the optical disk is unloaded, the optical disk drive drives the sliding block to move toward a second direction and the pin moves upwardly from the third height to the second height and then move downwardly from the second height to the first height.

7. The disk loading and unloading apparatus as claimed in claim 6, wherein when the pin moves downwardly from the second height to the first height, the optical disk is separated from the tray due to the interference with the tray.

8. The disk loading and unloading apparatus as claimed in claim 1, wherein the sliding groove further comprises a first inclined groove and a second inclined groove, wherein the length of the first inclined groove is longer than the length of the second inclined groove, and an angle is defined between the first inclined groove and the second inclined groove.
